(19) United States
(12) Patent Application Publication
(10) Pub. No.: US 2010/0053326 A1
(43) Pub. Date: Mar. 4, 2010

(54) IMAGE SENSOR, THE OPERATING METHOD AND USAGE THEREOF

(75) Inventors: Lihui Zhao, Shanghai (CN); Lixin Zhao, Shanghai (CN)

Correspondence Address: SCHWABE, WILLIAMSON & WYATT, P.C., 1420 FIFTH, SUITE 3010, SEATTLE, WA, 98101, US

(73) Assignee: GalaxyCore Inc., Shanghai (CN)

(21) Appl. No.: 12/553,041

(22) Filed: Sep. 2, 2009

(30) Foreign Application Priority Data
Sep. 3, 2008 (CN) 200810043757.3

(51) Int. Cl. H04N 7/18; H04N 5/335; H04N 5/228

(52) U.S. Cl. 348/143; 348/294; 348/222.1; 348/E05.091; 348/E07.085; 348/E05.031

(57) ABSTRACT

To solve the defect of the present image sensor used for obtaining both visible information and information indicating variation, such as low frame rate and being not applicable for portable apparatus, the present invention proposed an image sensor, operating method and usage thereof. The image sensor comprises an optoelectronic array, configured to convert optical signals of a first image and reference images at different moments into electronic signals, and the resolution of the optoelectronic array satisfying the requirement of visualization; a first module, configured to read the electronic signals of said first image by way of sampling, to read the electronic signals of each of said reference images by way of sampling, and to obtain the information indicating variation of the first image with respect to the reference images; and a second module, configured to read at least part of the electronic signals of one or more images, and to obtain at least part of visible information of the one or more images. The image sensor according to the present invention can output the visible information of the image at a suitable frame rate, and can also work at high frame rate and output the information indicating variation of the image, without consuming external resource and being especially applicable to the portable apparatus such as mobile phones.

### CROSS-REFERENCE TO RELATED APPLICATION

This application claims priority from Chinese patent application No.200810043757.3, entitled “An image sensor, the operating method and usage thereof” filed Sep. 3, 2008, which is hereby incorporated by reference to the extent it is consistent with the present specification.

### FIELD OF THE INVENTION

The present invention relates to sensors, and particularly to image sensors, the operating method and usage thereof.

### BACKGROUND OF THE INVENTION

In current art, the image sensors, whether based on CMOS or CCD, can be divided into two categories according to their functions: one category is the image sensors which output static or dynamic visible signal of the image, which is characterized in outputting uncompressed or compressed visible image signal to be recovered as the original image for visualization. Such image sensors are commonly used in consumer electronics using for photography, videography and surveillances. Its optoelectronic array generally reaches or exceeds ten thousands pixels, such that it can output the image signal which can be restored as visible image. The other category is the image sensors that only output the information indicating variation of the image, which is characterized in that it output the information indicating variation of the image at the current moment with respect to the images at the past moments, such as the movement and moving speed of some objects in the image, or the movement and rotation of the image itself. This kind of sensors is commonly used in optical mouse, to provide the location and movement of the mouse for the computer, and such information can be used by the computer to control other application functions, such as to control the movement of the mouse on the screen. In order to obtain the needed information indicating variation, it must process the image data of multiple frames, at a high frame rate such as at least 100 frames per second. The requirement for processing at high frame rate makes the data amount of each frame of processed image to be relatively small. Therefore, the resolution of the optoelectronic array of such kind of image sensors is small, such as smaller than ten thousand pixels.

It has become a hot spot in the current computers, game machines and mobile phones to sense and recognize the actions of the user, and to use the actions as the input instruction to control the computers, game machines and mobile phones. Compared with the method of sensing and recognizing actions based on the acceleration sensor which is commonly used in the game machines and mobile phones currently, the method of sensing and recognizing actions via the variation of the image captured by the image sensor is very reliable and convenient. In order to meet the requirement of such application, the computers, the game machines and mobile phones can be equipped with low-pixel image sensors and processing chip which are specifically used to output the information indicating variation of the image. However, its cost is high and it consumes large space. Alternatively, in order to save space, the high-pixel image sensor of the camera, already equipped on the device that outputs visible signal, can be used, and the movement detection can be realized by processing the visible signal by means of software or hardware at the rear end. However, in the case that the visible signal is processed for movement detection, since the resolution for the image sensor is high, the data amount of the visible signal is huge, which causes the processing device, using such huge image data for movement detection, must be powerful. On one hand, if the processing device is inside the image sensor, the image sensor will have high cost, complicated structure and large size, which is hard to be applied to the portable electronic products such as mobile phones; on the other hand, if the processing device is an external device of the image sensor, such as a software module operating on the processor of the mobile phone, it will consume the CPU processing time of the processor of the mobile phone, degrade its performance and consume the memory thereof, therefore increasing the cost of the whole mobile phone. Furthermore, no matter the information indicating variation is calculated by a processor inside the image sensor itself or by the processor of the external device, it costs a long time to read the visible huge data on the optoelectronic array of the image sensor, which cause the frame rate of the calculation for the information indicating variation to be hard to increase.

### SUMMARY OF THE INVENTION

Therefore, an image sensor that can output the visible information of the image as well as the information indicating variation of the image is desirable. Such image sensor should satisfy the requirements for high frame rate in both reading the data of pixels on the optoelectronic array and calculating the information indicating variation, and it also does not occupy external resource, and is easy to be used in portable apparatus. Preferably, such image sensor should have the advantages of low cost and small size.

To better address at least one of the above concerns, in embodiments according to one aspect of the invention, there is provided an image sensor, comprising: an optoelectronic array, configured to convert optical signals of images on said optoelectronic array into electronic signals, said images comprising a first image at a certain moment and at least one reference image at at least another moment, and the resolution of said optoelectronic array satisfying the requirement of visualization; the pixels of the image can be equivalent to the size of the optoelectronic array, or be smaller than the size of the optoelectronic array of the chip, such as to obtain QVGA, CIF or other image, whose resolution is smaller than VGA, from a VGA image sensor; a first module, configured to read the electronic signals of said first image by way of sampling from said optoelectronic array, to read the electronic signals of each of said reference images by way of sampling from said optoelectronic array, and to obtain the information indicating variation of said first image with respect to said reference image; a second module, configured to read at least part of the electronic signals of one or more said images from said optoelectronic array, and to obtain at least part of visible information of said one or more images.

Preferably, said first module further comprises: a reading circuit, configured to read the electronic signals of said images by way of sampling, wherein the reading circuit obtains first sampling signal through reading the electronic signals of said first image by way of sampling, and obtains each of second sampling signals through reading the electronic signals of each of said reference images by way of sampling; a memory, configured to store each of said second sampling signals; a processor, configured to load each of said second sampling signals from said memory, to obtain said first sampling signal from said reading circuit, and to calculate said information indicating variation according to said first sampling signal and each of said second sampling signals; wherein, the frame rate of reading the sampling signals by way of sampling and the data amount of the sampling signals satisfy the frame rate requirement of said processor for calculating said information indicating variation.

Further, said reading circuit reads the electronic signal by way of sampling at a frame rate more than 100 frames per second, the data amount of the sampled signal is smaller than five percent of the data amount of the electronic signal of said image. In one situation, said reading circuit reads the electronic signal on the optoelectronic array by way of sampling via selecting the pixels one the array at an interval of rows and/or columns. In another situation, said reading circuit reads the electronic signals on the optoelectronic array by way of sampling via accumulating the electronic signals of pixels on multiple rows and/or columns and reading the accumulated sampled value, and the processor is configured to average the accumulated sampled value for calculating said information indicating variation.

According to another aspect of the invention, there is provided an operating method for a image sensor, comprising the steps of: i. sensitizing images, to convert optical signals of images into electronic signals, said images comprising a first image at a certain moment and at least one reference image at at least another moment, and the resolution of said optoelectronic conversion satisfying the requirement of visualization; reading the electronic signals of said first image by way of sampling, and reading the electronic signals of each of said reference images by way of sampling, and obtaining the information indicating variation of said first image with respect to said reference images.

According to the embodiments of the invention, there is provided an image sensor that has both functions of outputting the visible information and information indicating variation of the image. The image sensor can output the visible information of the image at a frame rate that satisfies the requirement for visualization; it can also work at high frame rate, and output the information indicating variation of the image without consuming external resource. This image sensor is especially applicable to the resource-weak portable apparatus, such as mobile phone.

These and other features of the present invention will be described in details in the embodiment part.

### BRIEF DESCRIPTION OF THE DRAWINGS

Features, aspects and advantages of the present invention will become obvious by reading the following description of the non-limiting embodiments with the aid of appended drawings. Wherein, same or similar reference numerals refer to the same or similar steps or means.

FIG. 1 shows the structural diagram of the image sensor, according to one embodiment of one aspect of the present invention;

FIG. 2 shows flow chart for operating method of the image sensor, according to one embodiment of another aspect of the present invention;

FIG. 3 shows the structural block diagram of the surveillance device equipped with the image sensor, according to one embodiment of one aspect of the present invention.

### DETAILED DESCRIPTION OF EMBODIMENTS

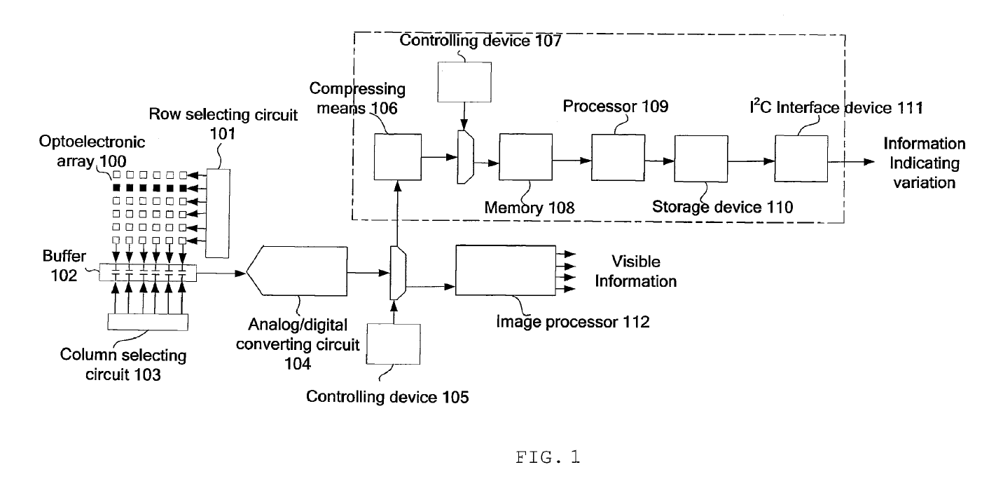

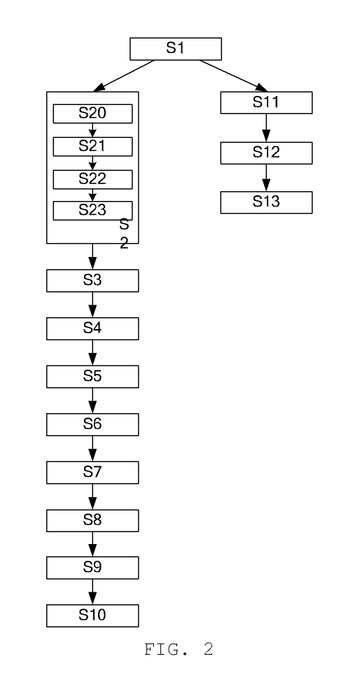

FIG. 1 shows a preferred embodiment according to one aspect of the present invention. The image sensor comprises an optoelectronic array, a first module configured to obtain the information indicating variation of the image, a second module configured to obtain the visible information of the image, and a controller configured to instruct either one of the first module and the second module to function solely, or both to function simultaneously. In order to satisfy the requirement for the second module to capture visible information of the image, the resolution of the optoelectronic array should reach more than ten thousand pixels, which currently can be the commonly used image sensors of Bayer Pattern with color filter array, more improved Foveon X3 sensor or 3CCD prism spectral sensors and other sensors. The first module preferably comprises a reading circuit, a compressing means, a memory, a processor, a storage device and an output interface. The second module preferably reuses the reading circuit and memory of the first module, and comprises an image processor. The operating method of each part of the image sensor and the operating method of the image sensor will be described in details with reference to FIG. 2.

Firstly, in step S1, at a certain moment, the image sensor sensitizes a reference image through the optoelectronic array 100, and converts the optical signal of the image to electronic signal, the data amount of the electronic signal provided by the optoelectronic array with the resolution of more than ten thousand pixels satisfies the requirement for visualization.

The controller of the image sensor instructs either one of the first module and the second module to function solely, or both to function simultaneously. For example, the controller comprises a register, which indicates three statuses using two bits of logical values. For example, 10 represents that the first module is at work while the second module is not at work; 01 represents that the first module is not at work while the second module is at work; 11 represents that the first module is at work and the second module is also at work. The first module and the second module respectively read the value in the register periodically, and determine their working status. The controller can receive the instruction from apparatus such as mobile phone which comprises the image sensor, and sets the logical value of the register to control the working status of the two modules.

When the first module determines that it is at work, then, in step S2, the reading circuit of the first module reads the electronic signal of the reference image by way of sampling from the optoelectronic array, and obtains the second sampling signal. The frame rate of reading the sampling signals by way of sampling and the data amount of the sampling signals after compressing satisfy the frame rate requirement of no less than 100 frames per second of said processor for calculating the information indicating variation.

To be specific, shown in FIG. 1, the reading circuit comprises a row selecting circuit 101, configured to select at least one row of pixels on the optoelectronic array; a buffer 102, comprising multiple buffer capacitors, all of which correspond to all columns of the optoelectronic array one to one. Each of multiple buffer capacitors respectively buffers the electronic signal of the pixel on its corresponding column on at least one row of the optoelectronic array selected by the row selecting circuit; a column selecting circuit 103, configured to select at least one buffer capacitor of the buffer, the row selecting circuit 101 and the column selecting circuit 103 functioning collaboratively to select pixels on said optoelectronic array by way of sampling; a analog/digital converting circuit 104, configured to conduct analog/digital conversion to the sampled electronic signals of said image, selected by said row selecting circuit and said column circuit by way of sampling, the frame rate for the reading circuit to read the second sampling signal should satisfy the frame rate more than 100 frames per second of the processor for calculating the information indicating variation, and the data amount of the obtained second sampling signal should satisfy the requirement for calculating the information indicating variation.

In a preferred embodiment, the reading circuit reads by way of sampling via selecting at an interval of rows and/or column.

In an embodiment, in step S20, the row selecting circuit 101 selects the rows of pixels on the optoelectronic array 100 at an interval of at least one row. In step S21, the buffer 102 buffers, column by column, electronic signals of one row of pixels of said optoelectronic array selected by said row selecting circuit. In step S22, the column selecting circuit 103 selects each column of the electronic signal in the electronic signal buffered by the buffer 102 in sequence. In step S23, the analog/digital converting circuit 104 conducts the analog/digital conversion to the electronic signals selected by said column circuit 103, so as to obtain the second sampling signal. The way of sampling increases the frame rate for reading the data, and the time for reading the second sampling signal should be less than 0.01 second, so as to satisfy the requirement for the frame rate of more than 100 frames per second for the processor to calculate the information indicating variation. It also reduces the data amount of the sampling signal. The second sampling signal is to be further compressed by the compressing means 106, so that the reused memory 108 inside the chip can store at least five frames of image, which satisfies the data requirement of the processor 109 for movement detection.

In another embodiment, in step S20′, the row selecting circuit 101 selects each row on the optoelectronic array 100 in sequence. In step S21′, the buffer 102 buffers, column by column, electronic signals of one row of pixels of said optoelectronic array selected by said row selecting circuit 101 each time. And in step S22′, the column selecting circuit 103 selects the electronic signal in the electronic signal buffered by the buffer 102 at an interval of at least one buffer capacitor, that is to say, at least one column. In step S23′, the analog/digital converting circuit 104 conducts the analog/digital conversion to the electronic signals selected by said column circuit 103 at an interval of at least one column, so as to obtain the second sampling signal. The way of sampling increases the frame rate for reading the data, and the time for reading the second sampling signal should be less than 0.01 second. It also reduces the data amount of the sampling signal. The second sampling signal is to be further compressed by the compressing means 106, so that the reused memory 108 inside the chip can store at least five frames of image, which satisfies the data requirement of the processor 109 for movement detection.

In yet another embodiment, the above two sampling ways are combined. In step S20″, the row selecting circuit 101 selects the rows of pixels on the optoelectronic array 100 at an interval of at least one row. In step S21″, the buffer 102 buffers, column by column, electronic signals of one row of pixels of said optoelectronic array selected by said row selecting circuit 101 at an interval of at least one row. In step S22″, the column selecting circuit 103 selects columns of the electronic signal in the electronic signal buffered by the buffer 102 at an interval of at least one column. In step S23″, the analog/digital converting circuit 104 conducts in sequence the analog/digital conversion to the electronic signals selected by said column circuit 103 at an interval of at least one column, so as to obtain the second sampling signal. The way of sampling increases the frame rate for reading the data, and the time for reading the second sampling signal should be less than 0.01 second. It also reduces the data amount of the sampling signal. The second sampling signal is to be further compressed by the compressing means 106, so that the reused memory 108 inside the chip can store at least five frames of image, which satisfies the data requirement of the processor 109 for movement detection.

In another preferred embodiment of the invention, the reading circuit reads by way of sampling via accumulating the sampling values of pixels on multiple rows and/or multiple columns, and reading the accumulated sampling values.

In an embodiment, the row selecting circuit 101 simultaneously selects multiple rows of pixels on the optoelectronic array 100 each time. The quantities of the electricity of each pixel in the same column in the selected rows are converged to the buffer capacitor corresponding to this column, so as to realize the accumulation of the sampling value by columns; the buffer 102 buffers the by-column accumulated sampling values of the electronic signals of the pixels in multiple rows of the optoelectronic array simultaneously selected by the row selecting circuit 101, so as to realize the function of the accumulation of the pixels in multiple rows and in one column. In particular, the color channels of the multiple pixels, which are accumulated by one column, can be the same or different. That is, it is not necessary to comply with the requirement of Bayer Pattern for restoring the original colorful image, for that the calculation for the information indicating variation needs neither interpolation for colors nor restoral for the original image. The column selecting circuit 103 selects each column of the electronic signals buffered by the buffer 102 in sequence. The analog/digital converting circuit 104 conducts analog/digital conversion on the by-column accumulated sampling values of electronic signals of multiple rows, so as to obtain the second sampling signal. The way of sampling increases the frame rate for reading the data, the time for reading the second sampling signal should be less than 0.01 second. It also reduces the data amount of the sampling signal. The second sampling signal is to be further compressed by the compressing means 106, so that the reused memory 108 inside the chip can store at least five frames of image, which satisfies the data requirement of the processor 109 for movement detection.

In another embodiment, the row selecting circuit 101 selects one row on the optoelectronic array 100; the buffer 102 buffers, by column, the electronic signals of the pixels of one row of the optoelectronic array selected by the row selecting circuit 101. The column selecting circuit 103 simultaneously selects multiple buffer capacitors in the buffer 101 each time, and the quantities of the electricity of multiple buffer capacitors are converged to the analog/digital converting circuit 104, so as to realize the accumulation of the sampling values of pixels in one row and in multiple columns. In particular, the color channels for the accumulated multiple pixels of multiple columns can be the same or different. That is, it is not necessary to comply with the requirement of Bayer Pattern for restoring the original colorful image, because the calculation for the information indicating variation needs neither interpolation for color nor restoral for the original image. The analog/digital converting circuit 104 conducts analog/digital conversion on the sampling values of electronic signals accumulated in one row and in multiple columns, so as to obtain the second sampling signal. The way of sampling increases the frame rate for reading the data, the time for reading the second sampling signal should be less than 0.01 second. It also reduces the data amount of the sampling signal. The second sampling signal is to be further compressed by the compressing means 106, so that the reused memory 108 inside the chip can store at least five frames of image, which satisfies the data requirement of the processor 109 for movement detection.

In yet another embodiment, the above two ways of sampling are conducted simultaneously. The row selecting circuit 101 simultaneously selects multiple rows of pixels of all rows of pixels on the optoelectronic array 100 each time. The quantities of the electricity of pixels in the selected rows are converged to the corresponding buffer capacitor in the buffer 102. The column selecting circuit 103 simultaneously selects multiple buffer capacitors in the buffer 101 each time, and the quantities of the electricity in multiple buffer capacitors are converged to the analog/digital converting circuit 104. The analog/digital converting circuit 104 conducts analog/digital conversion on the sampling values of electronic signals accumulated in multiple rows and in multiple columns, so as to obtain the second sampling signal. In particular, the color channels for the multiple pixels that are accumulated can be the same or different. That is, it is not necessary to comply with the requirement of Bayer Pattern for restoring the original colorful image, because the calculation for the information indicating variation needs neither interpolation for color nor restoral for the original image. The way of sampling increases the frame rate for reading the data, the time for reading the second sampling signal should be less than 0.01 second. It also reduces the data amount of the sampling signal. The second sampling signal is to be further compressed by the compressing means 106, so that the reused memory 108 inside the chip can store at least five frames of image, which satisfies the data requirement of the processor 109 for movement detection.

In still another preferred embodiment, the above two preferred ways for reading are used. The row selecting circuit 101 each time selects multiple rows at an interval of rows of pixels simultaneously. The quantities of the electricity of the multiple rows of pixels are converged to the buffer 102. The column selecting circuit 103 simultaneously selects multiple buffer capacitors at an interval of columns, and the quantities of the electricity in multiple buffer capacitors are converged to the analog/digital converting circuit 104 for being converted. Such method increases the frame rate for reading the data, which meets the requirement for the frame rate of the processor 109 to calculate the information indicating variation.

It is understandable that the size of the sampling signal of each frame can be determined according to the requirement for the frame rate of the processor 109 to calculate the information indicating variation, the processing capacity of the processor 109 and the size of the reusable memory 108 inside the chip; based on the size of the sampling signal, together with the resolution of the optoelectronic array 100 itself, an appropriate way of sampling can be determined, so that the frame rate and the data amount of the obtained sampling signal satisfies the requirement of the processor to calculate the information indicating variation, and all of the appropriate ways of sampling fall into the protection scope of the present invention.

Currently, in the industry, the reading circuit for optoelectronic array generally follows the sequence of selecting row, buffering row data, selecting column for the buffered row data and analog/digital converting, and the sensor uses the corresponding reading circuit for reading the sampling value of the pixels from the optoelectronic array. However, the present invention isn't limited to this. Other reading methods, such as first selecting column, then selecting row, and the corresponding reading circuits fall into the protection scope of the claims of the present invention. The present specification would not give unnecessary details about these methods and reading circuits.

And then, a controlling device 105 controls to provide the result of the analog/digital converting circuit 104 to the compressing means 106. In step S3, the compressing means 106 compresses the second sampling signal according to a compressing algorithm to obtain a compressed second sampling signal. The data amount of the compressed sampling signal further decreases, but still possesses the spatial character of the image, and is applicable to calculating the information indicating variation. Since there is no need to restore the original visible image signal, the compressing ratio can reach more than 100 times. The compressing means is implemented by way of digital circuit, and the applicable compressing algorithm can be for example the algorithm of accumulating and averaging the sampling image by blocks. It is understandable that calculating the information indicating variation of the image is a common technology for those ordinary technical persons in the art, and the compressing algorithms are not limited to the above example, any compressing algorithms, currently used or developed in the future that are applicable fall into the protection scope of the claims of the present invention. The data amount of the compressed sampling signal obtained by compressing means 106 satisfies the frame rate requirement of the processor for calculating the information indicating variation. For example, the processor should work at a frame rate of more than 100 frames per second, and the frame rate of the compressing means 106 should be at least 100 frames per second. It is understandable that in case that the frame rate is fixed, with the increase of the data amount that the processor 109 can process in unit time and the increase of the reusable memory 108, the size of the compressed sampling signal in each frame can increase accordingly. In this situation, the size of the second sampling signal that the reading circuit obtains can increases properly, or the compressing ratio of the compressing means 106 may decreases properly.

Then, a controlling device 107 provides the compressed second sampling signal to the memory 108. In step S4, the memory 108 stores the compressed second sampling signal. In practice, the memory can further comprise a Static Random Access Memory (SRAM). This memory 108 is included in the image sensor, which does not occupy the memory resources of the external devices.

Preferably, the image sensor works by way of pipelining, that is, in one clock cycle, the reading circuit, the analog/digital converting circuit 104, the compressing means 106 and the memory 108 works simultaneously and each processes one part of data and outputs the result to the next device. In the next clock cycle, each device respectively processes the input provided by the upper device, and provides the output to the next device, and so on. The way of pipelining has high working frame rates and small chip size. Finally, the second sampling signal of the reference image is stored in the memory 108.

Then, at another moment, for example for satisfying the frame rate of 100 frames per second, 0.01 second after sensitizing the reference signal, in step S5, the image sensor sensitizes a first image via the optoelectronic array, and converts the optical signal of the first image to electronic signal.

In step S6, the reading circuit of the first module reads the electronic signal of the first image by way of sampling from the optoelectronic array, to obtain the first sampling signal. The frame rate of the reading circuit for reading and obtaining the first sampling signal satisfies the frame rate requirement of the processor for calculating the information indicating variation. Similar to the above described methods of reading the reference image by way of sampling to obtain the second sampling signal, the reading circuit can reads the pixels of the optoelectronic array at an interval of rows and/or columns, and/or accumulates the sampling values of pixels of multiple rows and/or multiple columns to obtain the first sampling signal. The specific sampling methods can refer to the above detailed description and is omitted here. The time for reading the first sampling signal should be less than 0.01 second, so as to satisfy the requirement for the frame rate of more than 100 frames per second for the processor to calculate the information indicating variation, and the data amount of the obtained first sampling signal after compression should also satisfy the requirement for the processor to calculate the information indicating variation.

In step S7, the compressing means 106 compresses the first sampling signal according to a compressing algorithm to obtain a compressed first sampling signal. The operating method for the compressing means 106 can refer to the detailed description above and is omitted here.

Then, the controlling device 107 controls to provide the compressed first sampling signal for the processor 109. In step S8, the processor 109 loads the compressed second sampling signal from the memory 108 and obtains the compressed first sampling signal provided by compressing means 106. And the processor 109 calculates the information indicating variation of the first image with respect to the reference image by way of pipelining, according to the compressed first sampling signal and the compressed second sampling signal. The processor 109 is included in the image sensor, which does not occupy the memory resources of the external devices. In order to obtain the information indicating variation, the frame rate for the processor to calculate the information indicating variation is generally higher than 100 frames per second.

The processor 109 can be implemented by way of digital circuit, and uses corresponding algorithm firmed in the processor, for calculating the X, Y coordinates of the first sampling signal with respect to the second sampling signal, to calculate at least one item of the following information indicating variation:
the translational movement of at least part of the content of the first image with respect to at least one reference image, along at least any one axis of X, Y and Z;
the angle of rotation of at least part of the content of the first image with respect to at least one reference image, around at least any one axis of X, Y and Z;
the brightness variation of at least part of the content of said first image with respect to at least one reference image.

Since the time difference between the moment, at which the image sensor captures the reference image, and the moment, at which the image sensor captures the first image, is already known, according to the time difference and the above information indicating variation, the processor can adopt the method such as differentiation to calculate at least one item of the following information indicating variation:
the speed of translation of at least part of the content of the first image with respect to at least one reference image, along at least any one axis of X, Y and Z;
the angular speed of rotation of at least part of the content of the first image with respect to at least one reference image, along at least anyone axis of X, Y and Z.

In a preferred embodiment, the reading circuit obtains each part of the first sampling signal in sequence, such as accumulates values of pixels in one row from the first row to the last row of the optoelectronic array in sequence, so as to obtain the sampling signal of each row. In this situation, after the reading circuit obtains the sampling signal of the row, the processor 109 arranges the sampling data after analog/digital conversion into a M×N array. In order to save space, the processor uses the way of pipelining, and it first counts the N data of the first group, and then loads from the memory 108 the statistical signals of the second sampling signals corresponding to this group, such as the first group of N statistical data of the second sampling signals, and calculates the information indicating partial variation of the group of signals of the first image with respect to the first group of N statistical data of the second sampling signals. When the reading circuit reads the sampling value by way of sampling, the processor 109 in parallel calculates the information indicating variation, which further shortens the calculating time, and increases the calculating speed. All of information indicating partial variation, which corresponds to each group of signals of the first image with respect to each group of signals of the reference image one to one, comprises the information indicating variation of the whole first image with respect to the whole reference image.

Then, in step S9, the storage device 110 stores the calculated information indicating variation. For example, the storage device 110 can reuse the SRAM used as memory 108, or store in the register group. In another situation, the image sensor does not comprise storage module 110, and an output interface 111 directly outputs the information indicating variation, generated by the processor, in real time.

At last, in step S10, the output interface 111 outputs the information indicating variation in the storage device 110. Preferably, the output interface 111 is based on the serial communication protocol such as Inter-Integrated Circuit (I²C for short) protocol. It is understandable that the use of I²C interface is a preferred embodiment with small package size and few pin numbers. However, the present invention is not limited to this, the output interface can also use parallel output interface with 8 pins.

The above description uses the situation that the image sensor captures the first image and the reference image at one previous moment as an example to illustrate the present invention. It is understandable that, the image sensor can capture multiple reference images at multiple previous moments, and read each second sampling signal by way of sampling, and compress each second sampling signal and store the compressed signals. The processor also captures the first image at the current moment, reads the first sampling signal by way of sampling and compresses it. The processor calculates speed of translation of at least part of the content of each image with respect to its previous image along at least any one axis of X, Y and Z, or the angular speed of rotation of at least part of the content of each image with respect to its previous image around at least any one axis of X, Y and Z, according to the compressed sampling signals of the first image and each of the compressed sampling signals of multiple reference images at the previous multiple moments. Since the time difference between the moments at which the image sensor captures each image is already known, according to the time difference and the calculated speed, the processor can adopt the method such as differentiation to calculate at least one item of the following information indicating variation:
the acceleration of translation of at least part of the content of the first image with respect to at least one reference image, around at least any one axis of X, Y and Z;
the angular acceleration of rotation of at least part of the content of the first image with respect to at least one reference image, around at least any one axis of X, Y and Z.

It should be noted that, in the situation that the reading circuit accumulates sample values of the pixels on multiple rows and/or columns of the reference images, so as to obtain the second sampling signal, and accumulates each sample value of the pixel of multiple rows and/or columns of the first image, so as to obtain the first sampling signal, before the processor calculates the information indicating variation, the processor first calculates the accumulative equilibration of the sampling values, and then calculates the information indicating variation according to the equilibrated first sampling signal and the equilibrated second sampling signal.

By analyzing the above information indicating variation, the processor, or the processing device that is external of the image sensor can obtain the variation of scene that is captured by the image sensor, such as the user wave his/her hand or feet, swing his/her body, etc, or obtain the variation of the location of the image sensor itself, such as that the user who holds the mobile phone waves the mobile phone in his hand, and the speed of translation or speed of rotation of the variation of the scene and location, etc, or to recognize the mode of movement.

When the second module determines that this module functions, in step S11, it reads at least part of the electronic signals of each of at least one image from the optoelectronic array, and obtains at least part of the visible information according to the read at least part of the electronic signals of each of at least one image.

To be specific, the second module reuses the row selecting circuit 101, the buffer 102, the column selecting circuit 103, and analog/digital converting circuit 104. It reads at least part of the electronic signals of respective of at least one image from the optoelectronic array 100. The reading circuit can read all of signal of pixels from the optoelectronic array 100, or reads partial electronic signal by way of sampling at an interval of rows and/or column, or accumulated multiple rows and/or columns. In the situation that the method of accumulating multiple rows and/or columns, since the second module needs the visible information from which the original image can be obtained, therefore, the reading method for the reading circuit should comply with the requirement of Bayer Pattern, for example, the color channel of each of pixels that are accumulated together should be the same.

Then, the controlling device 105 controls to provide the at least part of the electronic signal of the image to the image processing means 112. In step S12, the second module reuses the memory 108, for example, SRAM to store the at least part of the electronic signal of the image.

Then, in step S13, the image processor 112 outputs the visible image signal via parallel or serial output interface.

The output frame rate of the second module can reach scores of frames per second, which satisfies the requirement for video watching and recording. It is understandable that the image sensor used for visible information and its operating principle is familiar to those skilled in the art, which is omitted here.

In the situation that the first module and the second module share the reading circuit and the memory, the cost for the image sensor is low, the size of the chip is small, and it does not need additional pins, which is compatible with the existing external device. It is understandable that, the present invention is not limited to this, the first module and the second module can use dedicated memories respectively, which may increase the size and cost of the image sensor to some extent.

It is understandable that, the function of the compressing means is to further decrease the data amount of the sampling signal, and ensures the frame rate and number of frame for the processor to calculating the information indicating variation, thus the compressing means is not indispensable in the present invention. When the data amount of the sampling signal read by the reading circuit already satisfies the frame rate requirement for the processor to calculating the information indicating variation, the compressing means can be removed away. Under the condition that the requirement for frame rate is satisfied, as the performance of the processor increases, the data amount of the sampling signal of one frame that the reading circuit reads can increase accordingly.

With the improvement of technology, the image sensor for visible information are used more and more widely, for example, most of the current mobile phones are equipped with image sensors for taking photos and videographing. However, the data amount of the original image of these image sensors is too huge; therefore, the image sensor cannot combines the function of calculating the information indicating variation and the function of taking photos. With the present invention, besides taking photos and videographing, the image sensor can sample and compress the image data, calculate the information indicating variation of the scene at a high frame rate, so as to determine the movement direction and the speed of the movement of the image sensor or the hand holding the image sensor, and uses these sensed parameters as inputs to control the manipulation of games, or manipulations of mobile phone or computer, so as to extend the application scope for the image sensor.

For example, in the mobile phone, when the user moves his/her mobile phone with its camera, the first module can obtain the information such as leftwards or rightwards movement of the scene; when the user wave hands towards the camera of the mobile phone, the first module can obtain the moving direction, speed of the user's hand. The first module provides the information to the baseband chip of the user's mobile phone via I²C interface. The baseband chip sends corresponding operating instruction to other components according to the information indicating variation. For example, the user is playing music at the moment, when the user sways the mobile phone, the first module obtains the information indicating variation of the left or right movement of the scene, the baseband chip switches the currently played music according to the variation. Further, selecting menu, controlling the mobile phone games and so one can all be conducted via the actions which are detected by image sensor according to the present invention, and this specification would not give unnecessary descriptions.

In the field of surveillance, the image sensor according to the present invention has some advantages, and it saves cost to some extent. The surveillance device that comprises this image sensor and its operating method are described as follows:

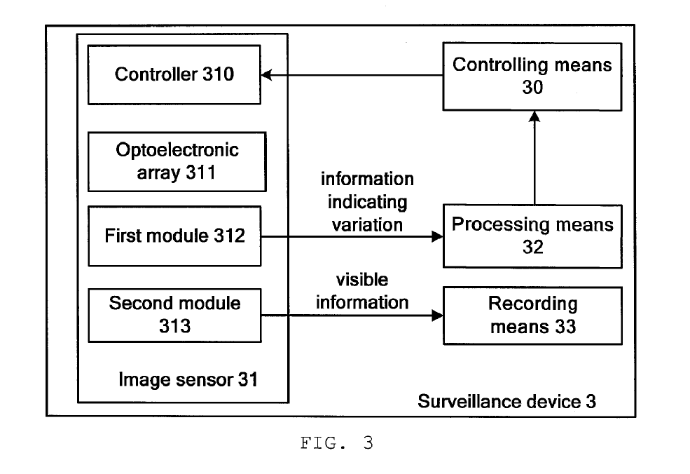

Referring to FIG. 3, the surveillance device 3 comprises a camera with the image sensor 31 according to the present invention, a controlling means 30, a processing means 32 connected to the output interface of the first module 312 of the image sensor 31, and a recording means 33 connected to the image processing means of the second module 313 of the image sensor 31.

Firstly, the controlling means 30 sets the controller 310 of the image sensor 31 to control the first module 312 to function, for example, it instructs the controller to set the logical value of the register as 10 or 11. In this situation, the optoelectronic array 311 of the image sensor sensitizes the first image at certain moment and at least one reference image at at least another moment. The first module 312 reads the sampling value of the pixels of the first image and the reference images obtained by the optoelectronic array by way of sampling, and obtained the information indicating variation of the first image with respect to the reference images.

Then, the processing means 32 obtains the information indicating variation of the first image with respect to the reference images via the output interface of the first module 312. It then determines whether the information indicating variation satisfies a recording condition, for example, whether the first image has changed with respect to the reference image:

When changes occur, it means that the surveiled scene has changed, and the surveillance device needs to record the image for later reviewing. Therefore, the controlling device 30 controls the recording means 33 to start to work, and sets the controller 310 of the image sensor 31 to control the second module 313 to start to work, for example, it instructs the controller to set the logical value of its register to 11. Therefore, the recording means 33 records the visible information of the image obtained by the image processor of the second module 313 of the image sensor 31.

When no change occurs, it means that the surveiled scene keeps the same, and the surveillance device does not need to record the image so as to save the storage for the useless images. Then, the controlling device 30 controls the recording means 33 to suspend working, and sets the controller 310 to control the second module 313 to suspend working, for example, it instructs the controller to set the logical value of its register to 10.

Besides whether change occurs, the first module 312 could also provide the direction and speed of the moving object for the processing means 32, and the surveillance device 3 could rotate or move its camera to follow the moving object, which improves the effect of surveillance.

Although the embodiments of the present invention have been explained hereinabove in detail, it should be noted that the above-described embodiments is for purpose of illustration only, and not to be construed as limitation of the invention. The present invention is not limited to these embodiments.

Those ordinary skilled in the art could understand and realize modifications to the disclosed embodiments, through studying the description, drawings and appended claims. All such modifications which do not depart from the spirit of the invention are intended to be included within the scope of the appended claims. The word “comprising” does not exclude the presence of elements or steps not listed in a claim or in the description. The word “a” or “an” preceding an element does not exclude the presence of a plurality of such elements. In the practice of present invention, several technical features in the claim can be embodied by one component. In the claims, any reference signs placed between parentheses shall not be construed as limiting the claim.

What is claimed is:

1. An image sensor, comprising:
an optoelectronic array, configured to convert optical signals of images on said optoelectronic array into electronic signals, said images comprising a first image at a certain moment and at least one reference image at at least another moment, and the resolution of said optoelectronic array satisfying the requirement of visualization;
a first module, configured to read the electronic signal of said first image byway of sampling, to read the electronic signals of each of said reference images by way of sampling, and to obtain the information indicating variation of said first image with respect to said reference images;
a second module, configured to read at least part of the electronic signals of one or more images, and to obtain at least part of visible information of the one or more images.

2. An image sensor according to claim 1, wherein said first module comprises:
a reading circuit, configured to read the electronic signals of said images by way of sampling, wherein the reading circuit obtains first sampling signal through reading the electronic signal of said first image by way of sampling, and obtains each of second sampling signals through reading the electronic signals of each of said reference images by way of sampling;
a memory, configured to store each of said second sampling signals;
a processor, configured to load each of said second sampling signals from said memory, to obtain said first sampling signal from said reading circuit, and to calculate said information indicating variation according to said first sampling signal and each of said second sampling signals;
wherein, the frame rate of reading the sampling signals by way of sampling and the data amount of the sampling signals satisfy the frame rate requirement of said processor for calculating said information indicating variation.

3. An image sensor according to claim 2, wherein, the frame rate of reading the sampling signals by way of sampling and the frame rate of said processor for calculating said information indicating variation are no less than 100 frames per second, said reading circuit comprising:
a row selecting circuit, configured to select at least one row of pixels on said optoelectronic array;
a buffer, configured to buffer, column by column, electronic signals of at least one row of pixels of said optoelectronic array selected by said row selecting circuit;
a column selecting circuit, configured to select at least one column of electronic signals from electronic signals buffered by said buffer, said row selecting circuit and said column selecting circuit functioning collaboratively to select pixels on said optoelectronic array by way of sampling;
an analog/digital converting circuit, configured to conduct analog/digital conversion to the electronic signals of pixels on said optoelectronic array of said image, selected by said row selecting circuit and said column circuit by way of sampling.

4. An image sensor according to claim 3, wherein said row selecting circuit is configured to select the row of pixels on said optoelectronic array at an interval of at least one row; and/or, said column selecting circuit is configured to select column of electronic signal from electronic signals buffered by said buffer at an interval of at least one column;
said analog/digital converting circuit conducts analog/digital conversion on the electronic signals of pixels of image, which are selected by said row selecting circuit and column selecting circuit at an interval of rows and/or columns;
wherein, said first sampling signal is obtained by selecting, at an interval of rows and/or columns, and analog/digital converting said first image, and said each of second sampling signals is obtained by selecting, at an interval of rows and/or columns, and analog/digital converting each of said reference images.

5. An image sensor according claim 3, wherein, said row selecting circuit is configured to simultaneously select at least two rows of pixels on said optoelectronic array each time, whereby the sampling values of the electronic signals on at least two rows, which are in the same or in the different color channel and are selected by said row selecting circuit, are accumulated by column, and said buffer is configured to buffer the by-column-accumulated sampling values of the electronic signals on at least two rows, which are in the same or in the different color channel and are selected by said row selecting circuit; and/or
said column selecting circuit is configured to simultaneously select at least two columns of electronic signals from electronic signals buffered by said buffer each time, whereby the sampling values of the electronic signals on at least two columns, which are in the same or in the different color channel and are selected by said column selecting circuit, are accumulated;
said analog/digital converting circuit conducts analog/digital conversion on the sampling values of electronic signals of at least two rows and/or columns in the same or in the different color channel which are selected and accumulated;
wherein, said first sampling signal is obtained by selecting and accumulating at least two rows of, and/or selecting and accumulating at least two columns of, and analog/digital converting said first image, and each of said second sampling signals is obtained by selecting and accumulating at least two rows of, and/or selecting and accumulating at least two columns of, and analog/digital converting each of said reference images;
said processor is further configured to conduct accumulation equilibrium by zone to said first sampling signal which are analog/digital converted, and to conduct accumulation equilibrium by zone to each of said second sampling signal which are analog/digital converted, and to calculate said information indicating variation according to said first sampling signal and each of said second signal which are equilibrated by zone.

6. An image sensor according to claim 2, wherein, said reading circuit and said memory sample and store said second sampling signal in way of pipelining;
said reading circuit samples each part of said first sampling signal in way of pipelining; and said processor functions in way of pipelining: as to each part, said processor obtains this part after said reading circuit reads this part, loads signals of each of said second sampling signal which are corresponding to this part from said memory, and calculates information indicating partial variation of this part with respect to the corresponding signals;
all of information indicating partial variation, each of which is corresponding to each part of said first signal one to one, constitutes said information indicating variation of said first image with respect to said reference images.

7. An image sensor according to claim 2, wherein, said first module further comprises:
a compressing means, configured to compress said first sampling signal and each of said second sampling signals according to one compression algorithm, the frame rate of said compressing means to compress said sampling signals and the data amount of the compressed sampling signals satisfy the frame rate requirement of said processor for calculating said information indicating variation;
said memory configured to store each of said compressed second sampling signals;
said processor configured to load each of said compressed second sampling signals from said memory, to obtain said first compressed sampling signal from said compressing means, and to calculate said information indicating variation according to said first compressed sampling signal and each of said second compressed sampling signals.

8. An image sensor according to claim 1, wherein said information indicating variation comprises at least any one of the following:
the signal of translational movement of at least part of the content of said first image with respect to said at least one reference image, along at least any one axis of X, Y and Z;
the signal of angle of rotation of at least part of the content of said first image with respect to said at least one reference image, around at least any one axis of X, Y and Z;
the signal of brightness variation of at least part of the content of said first image with respect to said at least one reference image;
the signal of speed of translation of at least part of the content of said first image with respect to said at least one reference image, along at least any one axis of X, Y and Z;
the signal of acceleration of translation of at least part of the content of said first image with respect to said at least one reference image, along at least any one axis of X, Y and Z;
the signal of angular speed of rotation of at least part of the content of said first image with respect to said at least one reference image, around at least any one axis of X, Y and Z;
the signal of angular acceleration of rotation of at least part of the content of said first image with respect to said at least one reference image, around at least any one axis of X, Y and Z.

9. An image sensor according to claim 1, wherein said first module further comprises:
a storage device, configured to store said information indicating variation.

10. An image sensor according to claim 1, wherein said first module further comprises:
an output interface, configured to output said information indicating variation of said first image.

11. An image sensor according to claim 10, wherein said output interface is based on communication protocol of Inter-Integrated Circuit.

12. An image sensor according to claim 2, wherein said second module reuses said reading circuit, and the reused reading circuit is configured to read at least part of the electronic signals of each of the one or more images from said optoelectronic array;
said second module reuses said memory, and the reused memory is configured to store said at least part of the electronic signals of each of the one or more images;
said second module further comprises:
an image processor, configured to load at least part of the electronic signals of the one or more images from said memory, conduct image processing and generate at least part of visible information of the one or more images.

13. An image sensor according to claim 1, further comprising:
a controller, configured to instruct either one of said first module and said second module to function solely, or both to function simultaneously.

14. A use of the image sensor according to claim 1, for using as an input device of portable apparatus.

15. A mobile phone, comprising the image sensor according to claim 1.

16. A surveillance apparatus, comprising the image sensor according to claim 13, and a recording means connected to the second module of said image sensor, said surveillance apparatus further comprising:
a controlling means, configured to set said controller to control said first module to function;
a processing means, configured to obtain information indicating variation of said first image with respect to said reference images provided by said first module, and to determine whether said information indicating variation satisfies a recording condition:
when the recording condition is satisfied, said controlling means controls said recording device to function, and sets said controller to control said second module to function, whereby said recording device records at least part of visible information of the one or more images obtained and provided by said image processing means;
otherwise, said controlling means controls said recording device to suspend functioning, and sets said controller to control said second module to suspend functioning.

17. An operating method of image sensors, comprising the steps of:
i. sensitizing images, to convert optical signals of images into electronic signals, said images comprising a first image at a certain moment and at least one reference image at at least another moment, and the resolution of said optoelectronic conversion satisfying the requirement of visualization;
ii. reading the electronic signals of said first image by way of sampling, reading the electronic signals of each of said reference images by way of sampling, and obtaining the information indicating variation of said first image with respect to said reference images.

18. A method according to claim 17, wherein said step ii comprises the steps of:
x. reading the electronic signals of said images byway of sampling, wherein obtaining first sampling signal through reading the electronic signal of said first image by way of sampling, and obtaining each of second sampling signals through reading the electronic signals of each of said reference images by way of sampling;
y. storing each of said second sampling signals;
z. loading each of said second sampling signals stored, obtaining said first sampling signal read, and calculating said information indicating variation according to said first sampling signal and each of said second sampling signals;
wherein, the frame rate of reading the sampling signals byway of sampling and the data amount of the sampling signals satisfy the frame rate requirement of calculating said information indicating variation.

19. A method according to claim 18, wherein, the frame rate of reading the sampling signals by way of sampling and the frame rate of said processor for calculating said information indicating variation are no less than 100 frames per second, a optoelectronic array is used for sensitizing images in said step i, and said step x comprising the steps of:
a. selecting at least one row of pixels on said optoelectronic array;
b. buffering, column by column, electronic signals of at least one row of pixels of said optoelectronic array selected;
c. selecting at least one column of electronic signals from electronic signals buffered, said row selecting step and said column selecting step operating collaboratively to select pixels on said optoelectronic array by way of sampling;
d. conducting analog/digital conversion to the electronic signals of pixels on said optoelectronic array of said image, row-selected, buffered and column-selected.

20. A method according to claim 19, wherein in said step a:
selecting the row of pixels on said optoelectronic array at an interval of at least one row;
and/or, in said step c:
selecting the column of electronic signal from electronic signals buffered by said buffer at an interval of at least one column;
in said step d:
conducting analog/digital conversion on the electronic signals of pixels of image, which are selected at an interval of rows and/or columns;
wherein, said first sampling signal is obtained by selecting, at an interval of rows and/or columns, and analog/digital converting said first image, and said each of second sampling signal is obtained by selecting, at an interval of rows and/or columns, and analog/digital converting each of said reference images.

21. A method according claim 19, wherein, in said step a, simultaneously selecting at least two rows of pixels on said optoelectronic array each time, whereby the sampling values of the electronic signals on at least two rows, which are in the same or in the different color channel and are selected by said row selecting circuit, are accumulated by column, and in said step b, buffering the by-column-accumulated sampling values of the electronic signals on at least two rows, which are in the same or in the different color channel and are selected by said row selecting circuit; and/or
in said step c, simultaneously selecting at least two columns of electronic signals from electronic signals buffered each time, whereby the sampling values of the electronic signals on at least two columns, which are in the same or in the different color channel and are selected by said column selecting circuit, are accumulated;
in said step d, conducting analog/digital conversion on the sampling values of electronic signals of at least two rows and/or columns in the same or in the different color channel which are selected and accumulated;
wherein, said first sampling signal is obtained by selecting and accumulating at least two rows of, and/or selecting and accumulating at least two columns of, and analog/digital converting said first image, and each of said second sampling signal is obtained by selecting and accumulating at least two rows of, and/or selecting and accumulating at least two columns of, and analog/digital converting each of said reference images;
in said step z: conducting accumulation equilibrium by zone to said first sampling signal which are analog/digital converted, and conducting accumulation equilibrium by zone to each of said second sampling signal which are analog/digital converted, and calculating said information indicating variation according to said first sampling signal and each of said second signal which are equilibrated by zone.

22. A method according to claim 18, wherein, said step x and said step y sample and store said second sampling signal in way of pipelining;
said step x samples each part of said first sampling signal in way of pipelining; and said step z functions in way of pipelining: as to each part, obtaining this part after said step x samples this part, loading signals of each of said second sampling signal which are corresponding to this part from said memory, and calculating information indicating partial variation of this part with respect to the corresponding signals;
all of information indicating partial variation, each of which is corresponding to each part of said first signal one to one, constitutes said information indicating variation of said first image with respect to said reference images.

23. A method according to claim 18, wherein, said step ii further comprises:
compressing said first sampling signal and each of said second sampling signals according to one compression algorithm, the frame rate of said compressing means to compress said sampling signals and the data amount of the compressed sampling signals satisfy the frame rate requirement of said processor for calculating said information indicating variation;
in said step y, storing said compressed second sampling signal;
in said step z, loading each of said compressed second sampling signals from said memory, obtaining said first compressed sampling signals from said compressing means, and calculating said information indicating variation according to said first compressed sampling signals and each of said second compressed sampling signals.

24. A method according to claim 18, wherein said information indicating variation comprises at least any one of the following:
the signal of translational movement of at least part of the content of said first image with respect to said at least one reference image, along at least any one axis of X, Y and Z;
the signal of angle of rotation of at least part of the content of said first image with respect to said at least one reference image, around at least any one axis of X, Y and Z;
the signal of brightness variation of at least part of the content of said first image with respect to said at least one reference image;
the signal of speed of translation of at least part of the content of said first image with respect to said at least one reference image, along at least any one axis of X, Y and Z;
the signal of acceleration of translation of at least part of the content of said first image with respect to said at least one reference image, along at least any one axis of X, Y and Z;
the signal of angular speed of rotation of at least part of the content of said first image with respect to said at least one reference image, around at least any one axis of X, Y and Z;
the signal of angular acceleration of rotation of at least part of the content of said first image with respect to said at least one reference image, around at least any one axis of X, Y and Z.

25. A method according to claim 17, wherein said step ii further comprises a step of:
storing said information indicating variation.

26. A method according to claim 17, wherein said step ii further comprises a step of:
outputting said information indicating variation of said first image.

27. A method according to claim 26, wherein said outputting step is based on communication protocol of Inter-Integrated Circuit.

28. A method according to claim 17, further comprising a step of:
iii. reading at least part of the electronic signals of one or more images, and to obtain at least part of visible information of the one or more images;
and a step of:
determining either one of said step ii and said step iii to operate solely, or both to operate simultaneously.

29. A method according to claim 28, wherein said step iii further comprising steps of:
reusing a reading circuit used in said step x, and reading at least part of the electronic signals of each of the one or more images from said optoelectronic array;
reusing a memory used in said step y, and storing said at least part of the electronic signals of each of the one or more images;
loading at least part of the electronic signals of the one or more images from said memory, conducting image processing and generating at least part of visible information of the one or more images.

30. A use of the method according to claim 17, for inputting information into portable apparatus.

31. A use according to claim 30, wherein said portable apparatus comprises mobile phones.

32. A method for surveillance, comprising the steps of:
sensitizing images, to convert optical signals of images into electronic signals, said images comprising a first image at a certain moment and at least one reference image at at least another moment, and the resolution of said optoelectronic conversion satisfying the requirement of visualization;
reading the electronic signals of said first image by way of sampling, reading the electronic signals of each of said reference images by way of sampling, and obtaining the information indicating variation of said first image with respect to said reference images;
determining whether said information indicating variation satisfies a recording condition:
when the recording condition is satisfied, reading at least part of the electronic signals of one or more images, obtaining at least part of visible information of the one or more images and recording the obtained at least part of visible information of the one or more images.
